(19) United States
(12) Patent Application Publication
(10) Pub. No.: US 2021/0165535 A1
(43) Pub. Date: Jun. 3, 2021

(54) TOUCH INPUT DEVICE AND METHOD

(71) Applicant: PayPal, Inc., San Jose, CA (US)

(72) Inventor: Fredrik Hyttnäs, Märsta (SE)

(21) Appl. No.: 16/618,326

(22) PCT Filed: May 28, 2018
(86) PCT No.: PCT/SE2018/050531

§ 371 Date: Nov. 29, 2019

(30) Foreign Application Priority Data
May 31, 2017 (SE) 1750683-3

(51) Int. Cl. G06F 3/0481; G06F 3/0486; G06F 3/0488

(52) U.S. Cl. CPC G06F 3/0481; G06F 3/04883; G06F 3/0486

(57) ABSTRACT

The disclosure proposes an electronic device and method for displaying and moving a cursor across a first part of a touchscreen in response to detection of a slide gesture applied to a second part of a touchscreen, activating a graphical user interface object indicated by the cursor after detection of a release of the slide gesture or detection of a discontinuation of the slide gesture or detection of a force-press gesture applied to the second part of the touchscreen.

### TECHNICAL FIELD

The disclosure pertains to a graphical user Interface of a touch screen for touch input at an electronic device.

### BACKGROUND

Many electronic devices such as computers make use of a separate input devices such as keyboards and cursor controllers, e.g. in form of a mouse or mousepad, for inputting information. With the introduction of the touchscreen, in particular for smartphones and tablets, input and output of information became possible without any dedicated input devices or physical keyboards, keys and cursor controllers on, or connected to, the electronic device. Typically a touchscreen of an electronic device is configured to display a graphical user interface for interaction with a user of the electronic device. The graphical user interface is adapted for input and output of information. An electronic device with such touchscreen is normally operated by a user that is touching the touchscreen with the user's fingers. If the electronic device is stationary or e.g. mounted in a stand, a user can operate the touchscreen with both hands via the graphical user interface without holding the electronic device Stationary touch screens can also be of any size.

Portable electronic devices can be equipped with small touch screens, such as a touch screen on a smartphone. Portable electronic devices can also be equipped with relatively large touch screens such as a touch screen on a tablet or on a portable computer.

If the electronic device is a portable electronic device a user can hold the electronic device with one hand and operate the electronic device with the fingers of the other hand. It is also quite common that a portable electronic device is held and operated with the same hand.

### SUMMARY

A graphical user interface of a touch screen typically comprises icons, menus and other graphical user interface objects that may be manipulated by a user via touch gestures on the touch screen. A problem that is familiar to most users of electronic devices such as e.g. smartphones and tablets, and other handheld electronic devices with a touchscreen, is that some graphical user interface objects are often out of reach when the electronic device is held and operated with one hand only, i.e. during one-handed use of the electronic device. During one-handed use of the electronic device, the thumb is normally the only finger available for tapping the touch screen.

While a thumb theoretically can sweep most of the touchscreen on all but the most oversized electronic devices, only approximately one third of the screen can be touched effortlessly, i.e. without stretching the thumb or shifting the device.

Several solutions have been proposed to solve the problem of effortless one-handed use of touch screen electronic devices. For example, some mobile phones have been provided with a graphical user interface allowing the home screen, or desktop, of the mobile phone and all the elements displayed thereon to be translated downwards by a swiping downward movement on a predefined area of the touchscreen, or by the press of a button, in this way, after translation of the home screen, also elements that are displayed close to the top of the home screen are in reach of the thumb.

Another known way of addressing the problem is to provide the mobile phone with a hard touchpad, i.e. a hardware-implemented touchpad, located on the back of the phone. Much like a traditional touchpad of a laptop computer, the touchpad on the back of the phone controls a cursor on the touchscreen, which cursor can be used to manipulate the objects of the graphical user interface. In this way, also graphical user interface objects that are out of reach for the thumb of the user during one-handed use of the mobile phone can be manipulated effortlessly.

It is an object of the present invention to present an alternative solution for effortless manipulation of graphical user interface objects of a touchscreen.

An object of the present disclosure is to provide a method and a device which seek to mitigate, alleviate, or eliminate one or more of the above-identified deficiencies and disadvantages in the art singly or in any combination.

The disclosure proposes an electronic device comprising a touchscreen for user interaction with graphical user interface objects displayed on the touchscreen. The electronic device further comprises a processor for activation of one of the graphical user interface objects in response to a detection of touch gesture applied to the touchscreen. The processor is configured to display and move a cursor across a first part of the touchscreen in response to a detection of slide gesture applied to a second part of the touchscreen. The second part of the touchscreen is different from the first part of the touchscreen. The processor is further configured to activate the graphical user interface object indicated by the cursor upon at least one of: detection of a release of the slide gesture; detection of a discontinuation of the slide gesture; or detection of a force-press gesture applied to the second part of the touchscreen. The touchscreen can hence be operated and touched effortlessly by the user, i.e. without stretching the thumb or shifting the device in order to activate a graphical user interface object that would otherwise be out of reach for the user.

Furthermore, the proposed solution allows a graphical user interface object that is physically out of reach to be activated through a single, continuous contact with the touchscreen. This is in contrast to known solutions, typically requiring the touchscreen or other parts of the electronic device to be tapped, touched or pressed at least twice in order to activate the graphical user interface object. The one-contact activation of physically unreachable graphical user interface objects significantly improves the user experience of the electronic device.

According to some aspects of the disclosure, the processor is configured to display a touchpad indicator at a touchpad indicator position, and to move the cursor in response to detection of the slide gesture applied to the touchpad indicator, in other words the slide gesture originating from the touchpad indicator position causes the cursor to move.

According to some aspects of the disclosure the processor is configured to receive user input indicating a desired touchpad indicator position, and to display the touchpad indicator at the desired touchpad indicator position in response to the reception of the user input. This means that the user can move the touchpad indicator to a desired position on the touchscreen where touching the touchscreen is convenient and where the touchscreen can hence be touched effortlessly by the user.

According to some aspects of the disclosure the above mentioned position-indicating user input comprises a drag-and-drop gesture applied to the touchpad indicator. Hence a user can easily move the touchpad indicator to a desired position.

According to some aspects of the disclosure, once the slide gesture for moving the cursor has been initiated, the processor is configured to activate only the graphical user interface object indicated by the cursor. This means that the processor will not activate a graphical user interface object that may be located where the user is applying the slide gesture when controlling the cursor.

According to some aspects of the disclosure the processor is configured to activate the touchpad indicator and display the cursor in response to a tap and hold gesture registered during a predefined time period at a same position of the touchscreen. In other words a user of a touchscreen can place a finger on the touchscreen and keep the finger at the same position of the touchscreen in order to activate the touchpad indicator and display the cursor.

According to some aspects of the disclosure, the processor may be configured to display the cursor only in response to a tap-and-hold gesture applied to an empty area of the touchscreen, i.e. an area that is void of interactive graphical user interface objects. This allows the functionality to be implemented e.g. as an inherent feature of an operating system of the electronic device while still allowing interaction through tap-and-hold gestures with other interactive graphical user interface object of the touchscreen.

According to some aspects of the disclosure the processor is configured to move the touchpad indicator in response to the drag-and-drop gesture only if the drag-and-drop gesture is preceded by a move-activating touch gesture, such as a double-tap gesture or a long-press gesture, applied to the touchpad indicator, the move-activating touch gesture causes the processor to move the touchpad indicator in response to the subsequent drag-and-drop gesture applied to the touchpad indicator, in this way there is less risk that the user moves the touchpad indicator unintentionally when the user is applying the slide gesture for moving the cursor.

According to some aspects of the disclosure the position-indicating user input comprises a multi-finger drag-and-drop gesture. This means that the user has to apply at least two fingers to the touchscreen when performing the drag-and-drop gesture. In this way, there is less risk that the user moves the touchpad indicator unintentionally when the user is applying the slide gesture for moving the cursor. Since the risk of unintentional movement of the touch indicator is reduced, the multi-finger drag-and-drop gesture does not necessarily have to be preceded by any move-activating gesture in order for the processor to move the touch indicator in response thereto,

According to some aspects of the disclosure the processor is configured to display the touchpad indicator in form of a superimposed graphical user interface object, wherein the superimposition is onto one or more of the graphical user interface objects that are displayed on the touchscreen. This means that the touchpad indicator is always on top and visible to the user of the touchscreen.

According to some aspects of the disclosure the processor is configured to move the cursor in response to the slide gesture originating from the location of the touchpad indicator only if the slide gesture is preceded by a move-activating touch gesture, such as a double-tap gesture or a long-press gesture, applied to the touchpad indicator, the move-activating touch gesture activates the function of moving the cursor in response to a slide gesture originating from the touchpad indicator position. In this way the user of the touchscreen can in a more distinct way indicate when the user intends to use the cursor for activating a graphical user interface object indicated by the cursor.

According to some aspects of the disclosure the processor is configured to display and move the cursor a certain distance in response to the slide gesture applied to the second part of the touchscreen, wherein the distance is dependent on the speed of the slide gesture. In other words the speed of the slide gesture influence the behaviour of the cursor on the touchscreen.

The disclosure further proposes a method in an electronic device configured for user interaction with graphical user interface objects displayed on a touchscreen of the electronic device. The method comprising: displaying and moving a cursor across a first part of the touchscreen in response to detection of a slide gesture applied to a second part of the touchscreen. The second part of the touchscreen being different from the first pan of the touchscreen. The method further comprises activating one of the graphical user interface objects indicated by the cursor upon at least one of: detection of a release of the slide gesture; detection of a discontinuation of the slide gesture; or detection of a force-press gesture applied to the second part of the touchscreen. The touchscreen can hence be touched effortlessly by the user, i.e. without stretching the thumb or shifting the device in order to activate a graphical user interface object that would otherwise be out of reach for the user.

According to some aspects of the disclosure the method comprising displaying a touchpad indicator at a touchpad indicator position within the second part, and moving the cursor in response to a slide gesture within the second part originating from the touchpad indicator position. In other words a slide gesture originating from the touchpad indicator position is moving the cursor.

According to some aspects of the disclosure the method comprising receiving user input indicating a desired location for the touch pad indicator on the touchscreen, and providing the touch pad indicator on the desired location of the touchscreen in response to the reception of the user input. This means that the user can move the touchpad indicator to a desired position on the touchscreen where touching the touchscreen is convenient and where the touchscreen can hence be touched effortlessly by the user.

According to some aspects of the disclosure the method comprising moving the touch pad indicator to the desired location of the touchscreen in response to a move gesture applied to the touchpad indicator. In other words a gesture originating from the touchpad indicator position is moving the touchpad area.

According to some aspects of the disclosure the method comprising moving the touch pad indicator to the desired location of the touchscreen in response to a drag-and-drop gesture applied to the touchpad indicator. Hence a user can easily move the touchpad indicator to a desired position by only using one finger.

According to some aspects of the disclosure the touchpad indicator is moved in response to the drag-and-drop gesture only if the drag-and-drop gesture is preceded by a move-activating touch gesture, such as a double-tap gesture or a long-press gesture, applied to the touchpad indicator, the move-activating touch gesture causes the touchpad indicator to be moved in response to a subsequent drag-and-drop gesture applied to the touchpad indicator. In this way there is less risk that the user moves the touchpad indicator unintentionally when the user is applying the slide gesture for moving the cursor.

According to some aspects of the disclosure the move gesture comprises a multi-finger drag-and-drop gesture. This means that the user has to apply at least two fingers. Hence in this way there is less risk that the user moves the touchpad indicator unintentionally when the user is applying the slide gesture with one finger for moving the cursor.

According to some aspects of the disclosure the touchpad indicator is displayed in form of a superimposed graphical user interface object, wherein the superimposition is onto one or more of the graphical user interface objects that are displayed on the touchscreen. This means that the touchpad indicator is always on top and visible to the user of the touchscreen.

According to some aspects of the disclosure the cursor is moved in response to the slide gesture originating from the location of the touchpad indicator only if the slide gesture is preceded by a touchpad-activating touch gesture, such as a double-tap gesture or a long-press gesture, applied to the touchpad indicator, the touchpad-activating touch gesture causes the cursor to be moved in response to detection of the slide gesture originating from the touchpad indicator position, in this way the user of the touchscreen can in a more distinct way indicate when the user intends to use the cursor for activating a graphical user interface object indicated by the cursor.

The above-described method is a computer-implemented method that is performed by the electronic device upon execution of a computer program stored in the device. The computer program may, for example, be executed by the above mentioned processor of the electronic device.

Consequently, the disclosure further proposes a computer program comprising computer-readable code which, when executed by a processor of an electronic touchscreen device, causes the device to perform the above-described method. Hence the code can be reproduced and run on plural different devices to perform the method.

The disclosure further proposes a computer program product comprising a non-transitory memory storing the computer program. Hence, the memory can maintain the code so that the method can be executed at any time.

The present invention relates to different aspects including the electronic device and method described above and in the following, and corresponding methods, electronic devices, uses and/or product means, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an exemplary block diagram illustrating components of an electronic device suitable for implementing the proposed invention.

FIG. 2 illustrates an electronic device having a touchscreen suitable for implementing the proposed invention.

FIG. 3 illustrates an exemplary user interface on an electronic device having a touchscreen.

FIGS. 4a and 4b illustrates reachable areas of a touchscreen during one-handed use of an electronic device.

FIGS. 5a and 5b illustrate a touchscreen with a cursor and a touch pad indicator of an electronic device according to some aspects of the disclosure.

FIGS. 6a and 6b illustrate a touchscreen with a cursor, and movement of the cursor, of an electronic device according to some aspects of the disclosure.

FIG. 7 illustrates a method according to some aspects of the disclosure.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

In the examples below, the invention will be described in with the context of an electronic device in form of a portable communications device, such as a mobile telephone or tablet, which portable communications device may comprise additional functions or applications, such as social media applications, navigation applications, payment applications, music applications, etc. Although described in the context of a portable communications device, it should be appreciated that the invention may be realized also in other types of electronic devices, such as touchscreen-provided laptops or tablet computers. It should also be appreciated that the electronic device does not have to be portable. The invention can be advantageously realized also in stationary electronic devices, such as touchscreen-provided desktop computers.

In the discussion that follows, an electronic device 10 that comprises touchscreen 14 is described. It should be understood, however, that the electronic device 10 optionally comprises one or more additional user-interface devices, such as a physical keyboard, a mouse and/or a joystick.

The electronic device 10 typically supports a variety of applications, such as one or more of the following: a social application, a navigator application, a payment application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

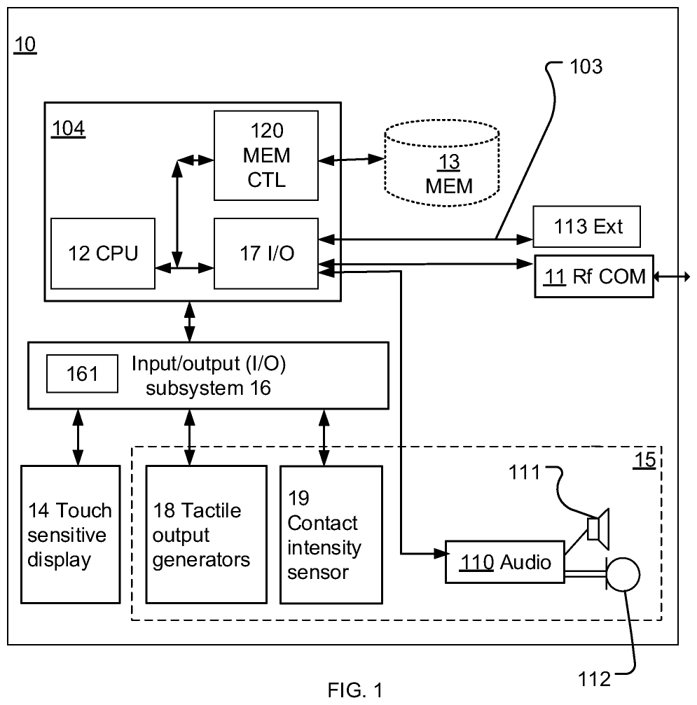

FIG. 1 is a block diagram illustrating components of an electronic device 10 in which the functionality described herein may be implemented. The electronic device 10 comprises a touchscreen 14, also known as a touch-sensitive display or a touch-sensitive display system. The word “touchscreen” is herein used for any touch-sensitive display screen capable of displaying a graphical user interface through which a user can interact with an electronic device by touching graphical user interface objects that are displayed on the touchscreen.

The electronic device 10 may comprise a memory 13 including one or more computer readable storage mediums, a memory controller 120, one or more processors 12, commonly called central processing units, peripherals interface 17, Radio Frequency circuitry 11, audio circuitry 110, a speaker 111, a microphone 112, an input/output, I/O, subsystem 16, and an external port 113. The electronic device 10 optionally comprises one or more optical sensors.

The electronic device 10 optionally comprises one or more intensity sensors for detection of intensity of contacts on the electronic device 10 e.g. a touchscreen 14 of the electronic device 10. The electronic device 10 optionally comprises one or more tactile output generators 18 for generating tactile outputs on the electronic device 10 e.g., generating tactile outputs on a touchscreen 14 of the electronic device 10. These components optionally communicate over one or more communication buses or signal lines 103. The electronic device 10 optionally comprises a vibrator 114 configured for causing the electronic device 10 to vibrate. The vibration might be an alternative to sound, when alerting a user about an event. According to some aspects of the disclosure a tactile feedback is generated upon a certain touch gesture. The tactile feedback is in one example generated by the vibrator 114.

The touchscreen 14 provides an input interface and an output interface between the device and a user. A display controller 161 function in the I/O subsystem 16 receives and/or sends electrical signals from/to touchscreen 14. Touchscreen 14 displays visual output to the user. The visual output optionally comprises graphics, text, icons, video, and any combination thereof collectively sometimes referred to as “graphics”. Some or all of the visual output corresponds to graphical user interface objects 35-38, 311-322 e.g. one or more soft keys, icons, web pages or images that are displayed on touchscreen 14 for enabling interaction with a user of the touchscreen 14. Hence the graphical user interface objects 35-38, 311-322 enables a direct manipulation, also referred to as a human-computer interaction, that allows a user to interact with the electronic device 10 thorough graphical objects visible on a touchscreen 14.

Touchscreen 14 has a touch sensitive surface, sensor or set of sensors that accepts input from the user based on haptic and/or tactile contact. Touchscreen 14 and display controller 161, along with any associated modules and/or sets of instructions in memory 13, detect contact, and any movement or breaking of the contact, on touchscreen 14 and converts the detected contact into interaction with graphical user interface objects e.g., one or more soft keys, icons, web pages or images that are displayed on touchscreen 14. In an exemplary embodiment, a point of contact between touchscreen 14 and the user corresponds to a finger of the user.

The touchscreen 14 optionally uses liquid crystal display, LCD, technology, light emitting polymer display, LPD, technology, or light emitting diode, LED, technology, although other display technologies are used in other embodiments.

Touchscreen 14 and display controller 161 optionally detect contact and any movement or breaking thereof using any of a plurality of touch sensing technologies for sensing touch in in X, Y and Z directions now known or later developed. Including but not limited to capacitive, resistive, infrared, and surface acoustic wave technologies, as well as other proximity sensor arrays and force sensors for sensing a force in the Z direction or other elements for determining one or more points of contact in X, Y and Z directions with touchscreen 14. In an exemplary embodiment, projected mutual capacitance sensing technology is used.

The user optionally makes contact with touchscreen 14 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

The electronic device 10 optionally also comprises one or more tactile output generators 18. FIG. 1 shows a tactile output generator coupled to I/O subsystem 16. Tactile output generator 18 optionally comprises one or more electroacoustic devices such as speakers or other audio components and/or electromechanical devices that convert energy into linear motion such as a motor, solenoid, electroactive polymer, piezoelectric actuator, electrostatic actuator, or other tactile output generating component e.g., a component that converts electrical signals into tactile outputs on the device. A contact intensity sensor 19 receives tactile feedback generation instructions from haptic feedback module and generates tactile outputs on electronic device 10 that are capable of being sensed by a user of device 10.

The software components stored in memory 13 comprise for example operating system, communication module or set of instructions, contact/motion module or set of instructions, graphics module or set of instructions, text input module or set of instructions, Global Positioning System GPS module or set of instructions, and applications or sets of instructions. Operating system e.g., iOS, Android, Darwin, RTXC, LINUX, UNIX, OS X, WINDOWS, or an embedded operating system such as VxWorks comprises various software components and/or drivers for controlling and managing general system tasks e.g., memory management, storage device control, power management, etc. and facilitates communication between various hardware and software components.

Applications optionally comprise the following modules or sets of instructions, or a subset or superset thereof: contacts module sometimes called an address book or contact list; telephone module; video conferencing module; e-mail client module; instant messaging module; workout support module; camera module for still and/or video images; image management module; browser module; calendar module; widget modules, which optionally comprise one or more of: weather widget, stocks widget, calculator widget, alarm clock widget, dictionary widget, and other widgets obtained by the user, as well as user-created widgets, widget creator module for making user-created widgets; search module; video and music player module, which is, optionally, made up of a video player module and a music player module notes module; map module; and/or online video module.

Examples of other applications that are, optionally, stored in memory 13 comprise other word processing applications, other image editing applications, drawing applications, presentation applications, JAVA-enabled applications, encryption, digital rights management, voice recognition, and voice replication.

The graphics module comprises various known software components for rendering and displaying graphics on touch screen 14 or other display, including components for changing the visual impact e.g., brightness, transparency, saturation, contrast or other visual property of graphics that are displayed. As used herein, the term “graphics” comprises any object that can be displayed to a user, including without limitation text, web pages, icons such as user-interface objects including soft keys, digital images, videos, animations and the like.

In some embodiments, graphics module stores data representing graphics to be used. Each graphic is, optionally, assigned a corresponding code. Graphics module receives, from applications etc., one or more codes specifying graphics to be displayed along with, if necessary, coordinate data and other graphic property data, and then generates screen image data to output to display controller 161.

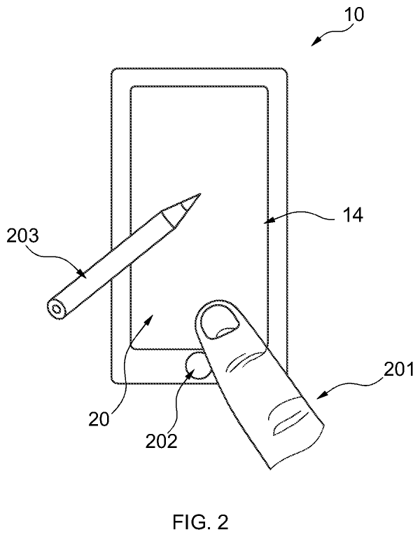

FIG. 2 illustrates the electronic device 10 having a touchscreen 14. The touchscreen 14 optionally displays one or more graphics within user interface, UI, 20. In this embodiment, as well as others described below, a user is enabled to select one or more of the graphics by making a gesture on the graphics, for example, with one or more fingers 201 or one or more styluses 203. In some embodiments, selection of one or more graphics, or interaction of graphical user interface objects, occurs when the user breaks contact with the one or more graphics or graphical user interface objects. In some embodiments, the gesture optionally comprises one or more taps, one or more swipes from left to right, right to left, upward and/or downward and/or a rolling of a finger from right to left, left to right, upward and/or downward that has made contact with electronic device 10. There are a plural different touch gestures that can be used to operate a touchscreen 14, for example:

Tap: Briefly touch surface with fingertip.

Double tap: Rapidly touch surface twice with fingertip.

Drag or slide: Move fingertip over surface without losing contact.

Drag and drop: Move fingertip over surface without losing contact to a certain position and then lift fingertip.

Flick: Quickly brush surface with fingertip.

Pinch: Touch surface with two fingers and bring them closer together.

Spread: Touch surface with two fingers and move them apart.

Press, also known as tap-and-hold or long-press: Touch surface for extended period of time.

Force-Press; also known as force-tap-and-hold or force-long-press: Touch surface with a certain force for extended period of time.

Press and tap: Press surface with one finger and briefly touch surface with second finger.

Press and drag: Press surface with one finger and move second finger over surface without losing contact.

Rotate: Touch surface with two fingers and move them in a clockwise or counter clockwise direction.

There may be further touch gestures or combinations of the above mentioned touch gestures. The majority of the touch gestures can also be combined with force, i.e. that the touch surface is touched with a certain force. A multi-finger touch gesture comprise at least two fingers. A multi-finger touch gesture can hence comprise any of, or a combination of, the above touch gestures.

The electronic device 10 optionally comprises one or more physical buttons, such as “home” or menu button 202. As described previously, menu button 202 is, optionally, used to navigate to any application in a set of applications that are, optionally executed on the electronic device 10. Alternatively, in some embodiments, the menu button is implemented as a soft key in a GUI displayed on touchscreen 14.

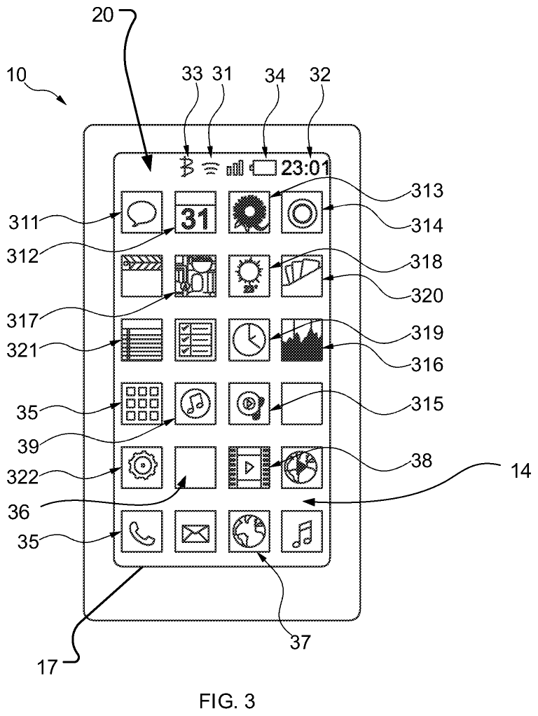

FIG. 3 illustrates an exemplary user interface for a menu of applications on the electronic device 10, where the proposed technique may be implemented. In some embodiments, user interface 20 comprises the following user interface objects, or a subset or superset thereof: Signal strength indicator 31 for wireless communication, such as cellular and Wi-Fi signals; Time 32; Bluetooth indicator 33 and Battery status indicator 34.

The user interface objects typically also comprises graphical user interface objects 35-38, 311-322 i.e. icons, corresponding to a number of applications such as; a telephone application 35, which optionally comprises an indicator of the number of missed calls or voicemail messages; e-mail application 36, which optionally comprises an indicator of the number of unread e-mails; browser application 37, and video player 38 and music player 39.

Other applications are e.g. messaging application 311, calendar application 312, image application 313, camera application 314, online video application 315, stocks application 316, map application 317, weather application 318, alarm clock application 319, workout application 320, notes application 321 and settings application 322. It should be noted that the icon labels illustrated in FIG. 3 are merely exemplary and that the proposed method might he applied on any graphical user interface object 35-38, 311-322.

In some embodiments, a label for a respective application icon comprises a name of an application corresponding to the respective application icon, in some embodiments, a label for a particular application icon is distinct from a name of an application corresponding to the particular application icon.

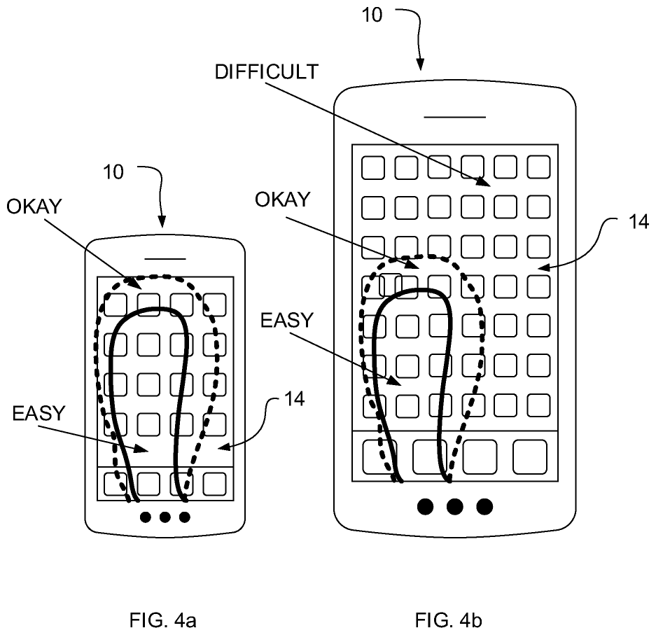

FIGS. 4a and 4b illustrates reachable areas of a touchscreen 14 during one-handed use of an electronic device 10. A problem that is familiar to most users of electronic devices 10 such as e.g. smartphones and tablets, and other handheld electronic devices 10 with a touchscreen 14, is that some graphical user interface objects 35-38, 311-322 are often out of reach when the electronic device 10 is held and operated with one hand only, i.e. during one-handed use of the electronic device 10. During one-handed use of the electronic device 10, the thumb is normally the only finger available for tapping the touch screen 14.

While a thumb theoretically can sweep most of the touchscreen 14 on all but the most oversized electronic devices 10, only approximately a third of the screen can be touched effortlessly, i.e without stretching the thumb or shifting the electronic device 10. FIG. 4a illustrates an electronic device 10 that has a size that can be touched effortlessly with a finger of a user, e.g. a thumb, during one-handed use in the area illustrated as “EASY” in FIG. 4a. The area illustrated as “OKAY” in FIG. 4a can be operated by the user with little more effort by stretching the thumb or shifting the electronic device 10. Hence, a major part of the touchscreen 14 of the electronic device 10 in FIG. 4a can he touched by the user.

In contrary to the electronic device 10 illustrated in FIG. 4a, the electronic device 10 illustrated in FIG. 4b has a touchscreen 14 of a much larger size. A major part of the touchscreen 14 of the electronic device 10 in FIG. 4b cannot be touched effortlessly with a finger of a user. This part is illustrated as “DIFFICULT” in FIG. 4b. In order for the user to operate the electronic device 10 in FIG. 4b, and in particular reach the “DIFFICULT” part, the user may have to use two hands, or to put down the electronic device 30 on a table or similar.

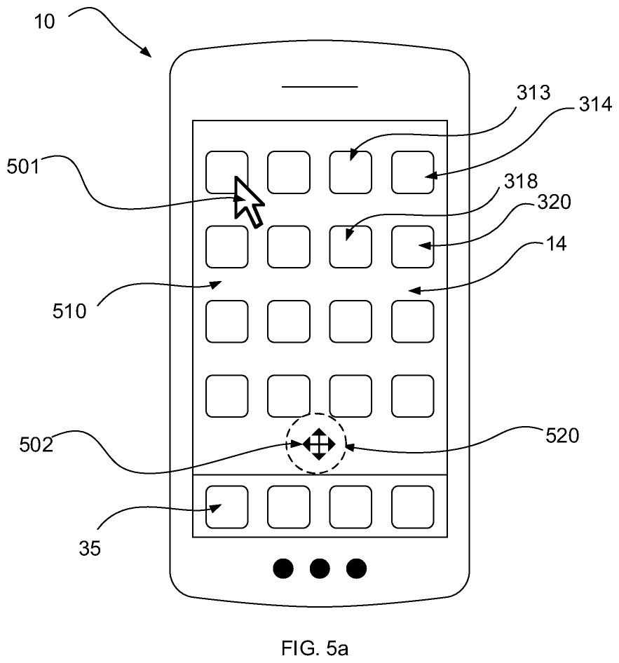

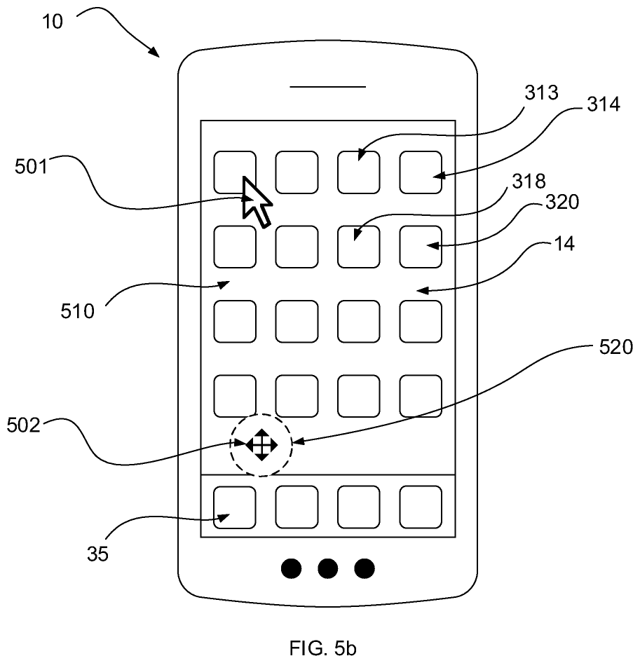

Reference is now made to FIGS. 5a and 5b that illustrates a touchscreen 14 with a cursor 501 and a touch pad indicator 502 of an electronic device 10 according to some aspects of the disclosure.

The disclosure proposes an electronic device 10 comprising a touchscreen 14 for user interaction with graphical user interface objects 35-38, 311-322 displayed on the touchscreen 14. The electronic device 10 further comprises a processor 12 for activation of one of the graphical user interface objects 35-38, 311-322 in response to detection of a touch gesture applied to the touchscreen 14. According to some aspects of the disclosure, the detected touch gesture applied to the touchscreen 14 is a detection of contact and any movement or breaking thereof. As mentioned above, touchscreen 14 and display controller 161 optionally detect contact and any movement or breaking thereof using any of a plurality of touch sensing technologies for sensing touch in in X, Y and Z directions now known or later developed, including but not limited to capacitive, resistive, infrared, and surface acoustic wave technologies, as well as other proximity sensor arrays and force sensors for sensing a force in the Z direction or other elements for determining one or more points of contact in X, Y and Z directions with touchscreen 14.

The processor 12 is configured to display and move a cursor 501 across a first part 510 of the touchscreen 14 in response to a detection of slide gesture applied to a second part 520 of the touchscreen 14. The cursor 501 is exemplified with an arrow in FIG. 5a and FIG. 5b. The cursor 501 can be any of any shape such as a square, triangle, cross, dot, circle, finger, or any shape or mark that helps the user to operate the touchscreen 14 of the electronic device 10.

The second part 520 of the touchscreen 14 is different from the first part 510 of the touchscreen 14. The second part 520 is typically surrounded by the first part 510. The second part 520 can also be located side-by-side the first part 510. According to some aspects of the disclosure, the second part 520 is significantly smaller than the first part 510. In one example the second part 520 has the size of a fingertip. In FIGS. 5a and 5b the second part 520 is illustrated with a dotted line. The dotted line may be invisible or visible for the user. According to some aspects of the disclosure the second part 520 is only adapted for detection of a slide gesture for moving the cursor 501. In one example the second part 520 can be located anywhere on the touchscreen 14. In one example the second part 520 moves along with the sliding gesture applied by the user. According to some aspects of the disclosure the second part 520 is defined by the location where the detected slide gesture is applied to the touchscreen 14 when moving the cursor 501.

The processor 12 is further configured to activate the graphical user interface object 35-38, 311-322 indicated by the cursor 501 upon at least one of: detection of a release of the slide gesture; detection of a discontinuation of the slide gesture; or detection of a force-press gesture applied to the second part of the touchscreen 14.

According to some aspects of the disclosure detection of a release of the slide gesture comprises detection of a cease, or breaking, of a touch input by the user. For example, when the user lifts up the finger that is used for touching the touchscreen 14, the processor 12 is detecting a release of the slide gesture. In one use case, the user can move around the cursor 501 with a slide gesture applied to the touchscreen 14. When the user indicates a certain graphical user interface object 35-38, 311-322 with the cursor 501 and lifts up the finger used for applying the slide gesture, the graphical user interface object 35-38, 311-322 indicated by the cursor 501 is activated. Hence, as long as the user applies a slide gesture to the touchscreen 14, there will be no detection of a release of the slide gesture.

According to some aspects of the disclosure detection of a discontinuation of the slide gesture comprising detection of a non-movement of touch input. According to some aspects of the disclosure the detection of a discontinuation of the slide gesture is dependent on time. In other words, the detection of a discontinuation of the slide gesture occurs a certain time after detection of a non-movement of touch input. In one example the time is 1 second. In one example the cursor 501 is associated with a graphical indicator that illustrates a countdown time for the user in any graphics. In one example a tactile feedback is given to the user in form of e.g. vibrations that becomes more intense the less time that is left of the countdown time. In one use case a user applies a slide gesture to the touchscreen 14 and moves around the cursor 501 while deciding which graphical user interface object 35-38, 311-322 that the user wants to activate. The user can move the cursor 501 over a number of different graphical user interface objects 35-38, 331-322. During movement of the cursor 501, the user may unintentionally pause a very short time on any graphical user interface object 35-38, 311-322 that is not intended for activation. With a certain time before activating a graphical user interface object 35-38, 311-322, after discontinuation of the slide gesture, there is less risk of unintentionally activating a graphical user interface object 35-38, 331-322 that is not intended for activation.

According to some aspects of the disclosure the time before activating a graphical user interface object 35-38, 311-322 after detection of a discontinuation of the slide gesture is visualized with graphics. The graphics can for example be a time glass, a clock, a gauge, a shrinking object, or a meter or any similar graphics that illustrates a countdown time before activation. In one example the graphics is associated with the cursor 501. In one example the graphics is a circle around the cursor 501 that starts to disappear the less time that is left before activation. The graphics gives the user a notification before activation of a graphical user interface object 35-38, 311-322 so that the user can continue to move the cursor 501 to another graphical user interface object 35-38, 311-322 if the wrong graphical user interface object 35-38, 311-322 was about to be activated.

According to some aspects of the disclosure the discontinuation of the slide gesture is defined by a threshold value for allowable movement caused by the slide gesture, in other words, even if the user is of the opinion that the slide gesture is discontinued, the touchscreen 14 can still detect a small movement that is not visible for the eye of a user. Hence, a threshold value that defines an allowable movement caused by the slide gesture can be set in order to make the user experience better for the user. The allowable movement can be dependent on position, acceleration or speed of the slide gesture.

According to some aspects of the disclosure the detection of a force-press gesture applied to the second part of the touchscreen 14 comprising detection of a force that is perpendicular to the surface of the touchscreen 14. In one example the touchscreen 14 is adapted to detect a force press gesture when the detected force is above a certain threshold. This is to avoid unintentional force-press when the user is applying the slide gesture. According to some aspects the electronic device 10 is adapted to generate tactile feedback to the user when detecting a force-press gesture. In one example, as mentioned previously, a contact intensity sensor 19 receives tactile feedback generation instructions from haptic feedback module and generates tactile outputs on electronic device 10 that are capable of being sensed by a user of the electronic device 10. The tactile feedback to the user helps the user to understand when the applied force-press gesture activates a graphical user interface object 35-38, 311-322 indicated by the cursor 501. In one example the tactile feedback is more intense the harder the applied force is. In one example there is no tactile feedback when the applied force is below a certain threshold value.

According to some aspects of the disclosure the detection of a force-press gesture can occur simultaneously as the slide gesture is detected. According to some aspects of the disclosure the detected force-pressure gesture is detected after discontinuation of the slide gesture.

The touchscreen 14 can hence be operated and touched effortlessly by the user, i.e. without stretching the thumb or shifting the device in order to activate a graphical user interface object that would otherwise be out of reach for the user.

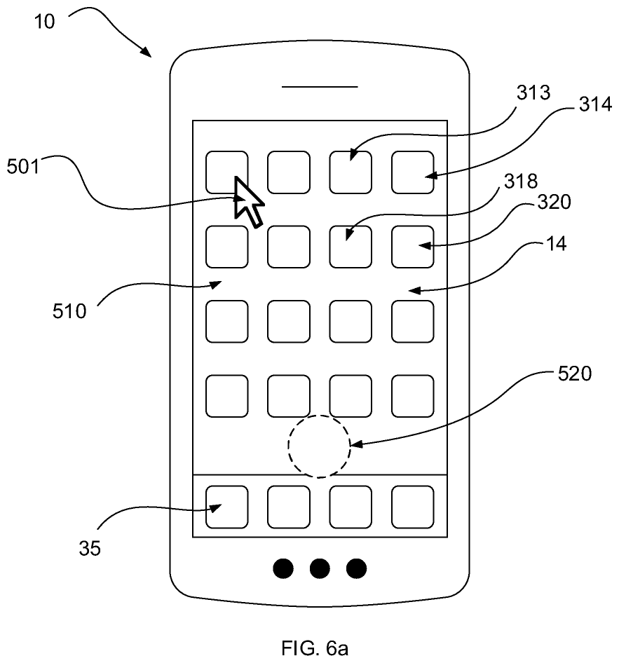

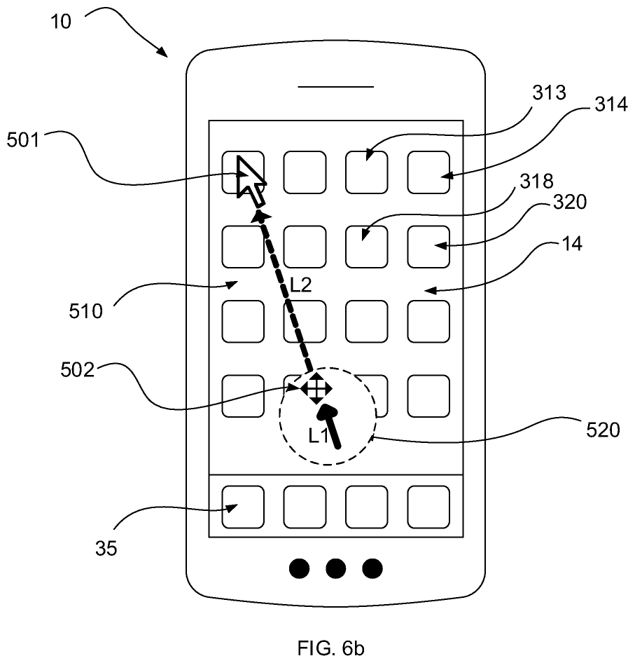

According to some aspects of the disclosure the processor 12 is configured to activate only the graphical user interface object 35-38, 311-322 indicated by the cursor 501. According to some aspects of the disclosure the second part 520 is defined by an area surrounding a finger that is applying the slide gesture to the touchscreen 14. In FIG. 6a second part 520 is illustrated with a dotted line but the second part 520 does not need to be visible for the user. In one example the second part 520 illustrated with a dotted line is visible to the user or the second part 520 is visualized to the user with certain graphics such as a semitransparent or blurry surface. Since the processor 12 is configured to activate only the graphical user interface object 35-38, 311322 indicated by the cursor 501 the finger applying the slide gesture can be placed almost on any other part of the touchscreen 14 that is not the first part that is hence defined by the part where the cursor 501 is located. This means that the processor will not activate a graphical user interface object that may be located where the user is applying the slide gesture when controlling the cursor.

According to some aspects of the disclosure, the processor is configured to display a touchpad indicator 502 at a touchpad indicator position, and to move the cursor 501 in response to detection of the slide gesture applied to the touchpad indicator 502. The touch pad indicator 502 is visualised by graphics in form of as a cross with four arrows in FIG. 5a and FIG. 5b. The touchpad indicator 502 can however have any look and shape such as a circle, square, ellipse, star or similar. The touchpad indicator 502 can be semi-transparent or visualized by a certain colour or a certain image.

When the user of the electronic device 10 applies a slide gesture to the touchpad indicator 502, the cursor 501 is moved according to the movement of the touchpad indicator 502. The movement of the cursor 501 is hence correlated with the slide gesture applied to the touchpad indicator 502. According to some aspects of the disclosure the slide gesture applied to the touchpad indicator 502 generates a greater and faster relative movement of the cursor 501 compare to the movement of the slide gesture applied to the touchpad indicator 502.

According to some aspects of the disclosure the touchpad indicator 502 is in the second part 520.

In the example illustrated in FIG. 6b the movement of the touchpad indicator 502 is illustrated with a black arrow named “L1” illustrating a distance L1. The movement L1 of the touchpad indicator 502 causes the cursor 501 to move a longer distance that is illustrated with a dotted line and arrow named “L2” in FIG. 6b.

In one example the quicker the slide gesture movement is, the quicker movement of the cursor 501. in one example the relative movement has a minimum relative movement value and a maximum relative movement value so that the cursor 501 cannot move faster or slower than a predetermined maximum and minimum speed. In one use case a user of the electronic device 10 with a large touchscreen 14 can only operate the electronic device 10 with one hand and is limited to the area illustrated as “EASY” in FIG. 4b. Preferably the touchpad indicator 502 is in the area illustrated as “EASY” and a small relative movement of the touchpad indicator 502 in that area enables the cursor 501 to activate any graphical user interface object 35-38,311-322 that is present on the touchscreen 14, in particular any graphical user interface object 35-38, 311-322 that is in the area illustrated as “DIFFICULT in FIG. 4b.

In other words a slide gesture originating from the touchpad indicator position is moving the cursor 501.

According to some aspects of the disclosure the processor 12 is configured to receive user input indicating a desired touchpad indicator position, and to display the touchpad indicator 502 at the desired touchpad indicator position in response to the reception of the user input. This means that the user can move the touchpad indicator 502 to a desired position on the touchscreen 14 where touching the touchscreen 14 is convenient and where the touchscreen 14 can hence be touched effortlessly by the user. In one example the user input indicating a desired location s made by a selection in a menu by the user. In one example the user input is a touch input.

FIG. 5a illustrates that the touchpad indicator 502 is positioned in the below centre part of the touchscreen 14. In FIG. 5b a user has moved the touchpad indicator 502 to the below left part of the touchscreen 14 e.g. to make it convenient for the user to reach the touchpad indicator 502 with the thumb.

According to some aspects of the disclosure the user input indicating a desired touchpad indicator position comprises a drag-and-drop gesture applied to the touchpad indicator 502. Hence a user can easily move the touchpad indicator 502 to a desired position by only using one finger.

According to some aspects of the disclosure the processor 12 is configured to activate the touchpad indicator 502 and display the cursor 501 in response to a tap-and-hold gesture registered during a predefined time period at a same position of the touchscreen 14. In other words a user of a touchscreen 14 can place a finger on the touchscreen 14 and keep the finger at the same position of the touchscreen 14 in order to activate the touchpad indicator and display the cursor 501. In one example the user can do this on any part of the touchscreen 14 where there is no graphical user interface object 35-38, 311-322. In one example the user is guided to place a finger on a dedicated spot that may be indicated. According to some aspects of the disclosure the processor 12 is configured to activate the touchpad indicator 502 and display the cursor 501 in response to a force-tap-and-hold gesture registered during a predefined time period at any position of the touchscreen 14. This means that a force-tap-and-hold gesture is dedicated for activating the he touchpad indicator 502 and display the cursor 501.

According to some aspects of the disclosure the processor 12 is configured to activate the touchpad indicator 502 and display the cursor 501 according to a specific setting in the electronic device 10. According to some aspects of the disclosure the processor 12 is configured to activate the touchpad indicator 502 and display the cursor 501 after activating a graphical user interface object 35-38, 311-322.

According to some aspects of the disclosure the processor 12 is configured to move the touchpad indicator 502 in response to the drag-and-drop gesture only if the drag-and-drop gesture is preceded by a move-activating touch gesture, such as a double-tap gesture or a long-press gesture, applied to the touchpad indicator 502, the move-activating touch gesture causes the processor 12 to move the touchpad indicator 502 in response to a subsequent drag-and-drop gesture applied to the touchpad indicator 502. In this way there is less risk that the user moves the touchpad indicator 502 unintentionally when the user is applying the slide gesture for moving the cursor 501.

According to some aspects of the disclosure the user input comprises a multi-finger drag-and-drop gesture. This means that the user has to apply at least two fingers. Hence in this way there is less risk that the user moves the touchpad indicator 502 unintentionally when the user is applying the slide gesture with one finger for moving the cursor 501.

According to some aspects of the disclosure the processor 12 is configured to display the touchpad indicator 502 in form of a superimposed graphical user interface object, wherein the superimposition is onto one or more of the graphical user interface objects 35-38, 311-322 that are displayed on the touchscreen 14. This means that the touchpad indicator 502 is always on top and visible for the user of the touchscreen 14. In one example the touchpad indicator 502 is semi-transparent so that any graphical user interface objects 35-38, 311-322 under the touchpad indicator 502 becomes visible.

According to some aspects of the disclosure the processor 12 is configured to move the cursor 501 in response to the slide gesture originating from the location of the touchpad indicator 502 only if the slide gesture is preceded by a move-activating touch gesture, such as a double-tap gesture or a long-press gesture, applied to the touchpad indicator, the move-activating touch gesture activates the function of moving the cursor 501 in response to a slide gesture originating from the touchpad indicator position. In this way the user of the touchscreen 14 can in a more distinct way indicate when the user intends to use the cursor 501 for activating a graphical user interface object 35-38, 311-322 indicated by the cursor instead of using e.g. a finger or a stylus for activating a graphical user interface object 35-33, 311-322.

According to some aspects of the disclosure the processor 12 is configured to display and move the cursor 501 a certain distance in response to the slide gesture applied within second part 520, wherein the distance is dependent on the speed of the slide gesture. In other words the speed of slide gesture influence the appearance of the cursor 501 on the touchscreen 14. In one example the quicker the slide gesture movement is, the quicker movement of the cursor 501. In one example the relative movement has a minimum relative movement value and a maximum relative movement value so that the cursor 501 cannot move faster or slower than a predetermined maximum and minimum speed. According to some aspects of the disclosure the distance is dependent on the acceleration of the slide gesture. In one example if there is no acceleration in the slide gesture, the cursor 501 moves with the same speed as the finger causing the slide gesture.

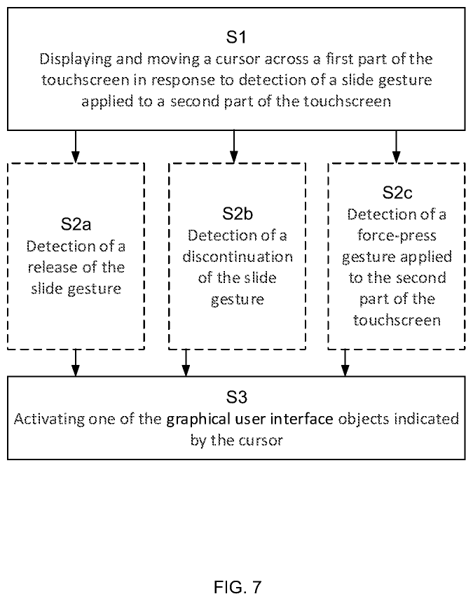

The disclosure further proposes a method in an electronic device 10 configured for user interaction with graphical user interface objects 35-38, 311-322 displayed on a touchscreen 14 of the electronic device 10. The method, illustrated in FIG. 7, comprising: S1 displaying and moving a cursor 501 across a first part 510 of the touchscreen 14 in response to detection of a slide gesture applied to a second part 520 of the touchscreen 14. The second part 520 of the touchscreen 14 being different from the first part 510 of the touchscreen 14. The method further comprises S3 activating one of the graphical user interface objects 35-38, 311-322 indicated by the cursor 501 upon at least one of: S2a detection of a release of the slide gesture; S2b detection of a discontinuation of the side gesture; or S2c detection of a force-press gesture applied to the second part 520 of the touchscreen 14.

According to some aspects of the disclosure detection of a release of the slide gesture comprises detection of a cease, or breaking, of a touch input by the user. For example, when the user lifts up the finger that is used for touching the touchscreen 14, the processor 12 is detecting a release of the slide gesture. In one use case, the user can move around the cursor 501 with a slide gesture applied to the touchscreen 14. When the user indicates a certain graphical user interface object 35-38, 311-322 with the cursor 501 and lifts up the finger used for applying the slide gesture, the graphical user interface object 35-38, 311-322 indicated by the cursor 501 is activated. Hence, as long as the user applies a slide gesture to the touchscreen 14, there will be no detection of a release of the slide gesture.

According to some aspects of the disclosure detection of a discontinuation of the slide gesture composing detecting a non-movement of touch input. In one example the cursor 501 has a graphical indicator that illustrates a countdown time for the user. According to some aspects of the disclosure the detection of a discontinuation of the slide gesture is dependent on time. In other words, the detection of a discontinuation of the slide gesture occurs a certain time after detection of a non-movement of touch input. In one example the time is 1 second. In one use case a user applies a slide gesture to the touchscreen 14 and moves around the cursor 501 while deciding which graphical user interface object 35-38, 311-322 that the user wants to activate. The user can move the cursor 501 over a number of different graphical user interface objects 35-38, 311-322. During movement of the cursor 501, the user may unintentionally pause a very short time on any graphical user interface object 35-38, 311-322 that is not intended for activation. With a certain time before activating a graphical user interface object 35-38, 311-322, after discontinuation of the slide gesture, there is less risk of unintentionally activating a graphical user interface object 35-38, 311-322 that is not intended for activation.

According to some aspects of the disclosure the time before activating a graphical user interface object 35-38, 311-322 after detection of a discontinuation of the slide gesture is visualized with graphics. The graphics can for example be a time glass, a clock, a gauge, a shrinking object, or a meter or any similar graphics that illustrates a countdown time before activation. In one example the graphics is associated with the cursor 501. In one example the graphics is a circle around the cursor 501 that starts to disappear the less time that is left before activation. The graphics gives the user a notification before activation of a graphical user interface object 35-38, 311-322 so that the user can continue to move the cursor 501 to another graphical user interface object 35-38, 311-322 if the wrong graphical user interface object 35-38, 311-322 was about to be activated.

According to some aspects of the disclosure the discontinuation of the slide gesture is defined by a threshold value for allowable movement caused by the slide gesture. In other words, even if the user is of the opinion that the slide gesture is discontinued, the touchscreen 14 can still detect a small movement that is not visible for the eye of a user. Hence, a threshold value that defines an allowable movement caused by the slide gesture can be set in order to make the user experience better for the user. The allowable movement can be dependent on position, acceleration or speed of the slide gesture.

According to some aspects of the disclosure the detection of a force-press gesture applied to the second part or the touchscreen 14 comprising detection of a force that is perpendicular to the surface of the touchscreen 14. In one example the touchscreen 14 is adapted to detect a force-press gesture when the detected force is above a certain threshold. This is to avoid unintentional force-press when the user is applying the slide gesture. According to some aspects the electronic device 10 is adapted to generate tactile feedback to the user when detection of a force-press gesture. In one example, as mentioned previously, a contact intensity sensor 19 receives tactile feedback generation instructions from haptic feedback module and generates tactile outputs on electronic device 10 that are capable of being sensed by a user of the electronic device 10. The tactile feedback to the user helps the user to understand when the applied force-press gesture activates a graphical user interface object 35-38, 311-322 indicated by the cursor 501. In one example the tactile feedback is more incense the harder the applied force is. In one example there is no tactile feedback when the applied force is below a certain threshold value.

According to some aspects of the disclosure the detection of a force-press gesture can occur simultaneously as the slide gesture is detected. According to some aspects of the disclosure the detected force-pressure gesture is detected after discontinuation of the slide gesture.

The touchscreen 14 can hence be operated and touched effortlessly by the user, i.e. without stretching the thumb or shifting the device in order to activate a graphical user interface object 35-38, 311-322 that would otherwise be out of reach for the user.

According to some aspects of the disclosure the method comprising displaying a touchpad indicator 502 at a touchpad indicator position within the second part 520, and moving the cursor 501 in response to a slide gesture within the second part 520 originating from the touchpad indicator position. In other words a slide gesture originating from the touchpad indicator position is moving the cursor 501.

According to some aspects of the disclosure the method comprising receiving user input indicating a desired location for the touchpad indicator 502 on the touchscreen 14, and providing the touchpad indicator 502 on the desired location, of the touchscreen 14 in response to the reception of the user input. This means that the user can move the touchpad indicator 502 to a desired position or the touchscreen 14 where touching the touchscreen 14 is convenient and where the touchscreen 14 can hence be touched effortlessly by the user.

According to some aspects of the disclosure the method comprising moving the touchpad indicator 502 to the desired location of the touchscreen 14 in response to a move gesture applied to the touchpad indicator 502. In other words a gesture originating from the touchpad indicator position is moving the touchpad indicator 502.

According to some aspects of the disclosure the method comprising moving the touchpad indicator 502 to the desired location of the touchscreen 14 in response to a drag-and-drop gesture applied to the touchpad indicator 502. Hence a user can easily move the touchpad indicator 502 to a desired position by only using one finger.

According to some aspects of the disclosure the touchpad indicator 502 is moved in response to the drag-and-drop gesture only if the drag-and-drop gesture is preceded by a move-activating touch gesture, such as a double-tap gesture or a long-press gesture, applied to the touchpad indicator 502, the move-activating touch gesture causes the touchpad indicator 502 to be moved in response to a subsequent drag-and-drop gesture applied to the touchpad indicator 502. In this way there is less risk that the user moves the touchpad indicator 502 unintentionally when the user is applying the slide gesture for moving the cursor 501.

According to some aspects of the disclosure the move gesture comprises a multi-finger drag-and-drop gesture. This means that the user has to apply at least two fingers. Hence in this way there is less risk that the user moves the touchpad indicator 502 unintentionally when the user is applying the slide gesture with one finger for moving the cursor 501.

According to some aspects of the disclosure the touchpad indicator 502 is displayed in form of a superimposed graphical user interface object, wherein the superimposition is onto one or more of the graphical user interface objects 35-38, 311-322 that are displayed on the touchscreen 24 This means that the touchpad indicator 502 is always or top and visible for the user of the touchscreen 14.

According to some aspects of the disclosure the cursor 501 is moved in response to the slide gesture originating from the location of the touchpad indicator 502 only if the slide gesture is preceded by a move-activating touch gesture, such as a double-tap gesture or a long-press gesture, applied to the touchpad indicator 502, the move-activating touch gesture causes the cursor 501 to be moved in response to detection of the slide gesture originating from the touchpad indicator position. In this way the user of the touchscreen 14 can in a more distinct way indicate when the user intends to use the cursor 501 for activating a graphical user interface object 35-38, 311-322 indicated by the cursor.

The disclosure further proposes a computer program comprising computer-readable code which, when executed by a processor 12 of an electronic device 10, causes the electronic device 10 to perform the method. Hence the code can be reproduced and run on plural different electronic devices 10 to perform the method. According to some aspects of the disclosure, the method is carried out by instructions in a computer program that is downloaded and run on an electronic device 10. In one example the computer program is a so called app. The app is either free or can be bought by the user of the electronic device 10. The same app can generate a user interface for user interaction via a touchscreen 14 of an electronic device 10.

The disclosure further proposes a computer program product comprising a non-transitory memory storing a computer program. Hence, the memory can maintain the code so that the method can be executed at any time.

In the drawings and specification, there have been disclosed exemplary aspects of the disclosure. However, many variations and modifications can be made to these aspects. Accordingly, although specific terms are employed, they are used in a generic and descriptive sense only and not for purposes of limitation, the scope of the aspects being defined by the following claims.

1. An electronic device, comprising:
a touchscreen for user interaction with graphical user interface objects displayed on the touchscreen,
a processor for activation of one of the graphical user interface objects in response to detection of a touch gesture applied to the touchscreen,
the processor is configured to:
activate a touchpad indicator and display a cursor in response to a tap-and-hold gesture registered during a predefined time period at a same position of the touchscreen;
display the touchpad indicator at a touchpad indicator position, and to move a cursor in response to detection of a slide gesture applied to the touchpad indicator;
display and move the cursor across a first part of the touchscreen in response to detection of the slide gesture being applied to a second part of the touchscreen, the second part of the touchscreen being different from the first part of the touchscreen; and
activate the graphical user interface object indicated by the cursor upon at least one of
detection of a release of the slide gesture;
detection of a discontinuation of the slide gesture; or
detection of a force-press gesture applied to the second part of the touchscreen.

2. The electronic device of claim 1, wherein the processor is configured to receive user input indicating a desired touchpad indicator position; and to display the touchpad indicator at the desired touchpad indicator position in response to the reception of the user input.

3. The electronic device of claim 2, wherein the user input comprises detection of a drag-and-drop gesture applied to the touchpad indicator.

4. The electronic device of claim 3, wherein the processor is configured to move the touchpad indicator in response to detection of the drag-and-drop gesture only if the drag-and-drop gesture is preceded by a detection of a move-activating touch gesture, such as a double-tap gesture or a long-press gesture, applied to the touchpad indicator, the move-activating touch gesture causes the processor to move the touchpad indicator in response to a subsequent drag-and-drop gesture applied to the touchpad indicator.

5. The electronic device of claim 2, wherein the user input comprises detection of a multi-finger drag-and-drop gesture.

6. The electronic device of claim 2, wherein the processor is configured to display the touchpad indicator in form of a superimposed graphical user interface object, wherein the superimposition is onto one or more of the graphical user interface objects that are displayed on the touchscreen.

7. The electronic device of claim 1, wherein the processor is configured to move the cursor in response to detection of the slide gesture originating from the location of the touchpad indicator only if the slide gesture is preceded by detection of a touchpad-activating touch gesture, such as a double-tap gesture or a long-press gesture, applied to the touchpad indicator, the touchpad-activating touch gesture activates the function of moving the cursor in response to detection of the slide gesture originating from the touchpad indicator position.

8. The electronic device of any of the preceding claims, wherein the processor is configured to display and move the cursor a certain distance in response to detection of the slide gesture applied within the second part, wherein the distance is dependent on the speed of the slide gesture.

9. A method, in an electronic device, for user interaction with graphical user interface objects displayed on a touchscreen of the electronic device, the method comprising:
activating a touchpad indicator and display a cursor in response to a tap-and-hold gesture registered during a predefined time period at a same position of the touchscreen;
displaying the touchpad indicator at a touchpad indicator position, and to move a cursor in response to detection of a slide gesture applied to the touchpad indicator;
displaying and moving a cursor across a first part of the touchscreen in response to detection of a slide gesture being applied to a second part of the touchscreen, the second part of the touchscreen being different from the first part of the touchscreen; and
activating one of the graphical user interface objects indicated by the cursor upon at least one of
detection of a release of the slide gesture;
detection of a discontinuation of the slide gesture; or
detection of a force-press gesture applied to the second part of the touchscreen.

10. The method of claim 9, comprising receiving user input indicating a desired location for the touch pad indicator on the touchscreen, and providing the touch pad indicator on the desired location of the touchscreen in response to the reception of the user input.

11. The method of claim 10, comprising moving the touch pad indicator to the desired location of the touchscreen in response to detection of a move gesture applied to the touchpad indicator.

12. The method of claim 11, comprising moving the touch pad indicator to the desired location of the touchscreen in response to detection of a drag-and-drop gesture applied to the touchpad indicator.

13. The method of claim 12, wherein the touchpad indicator is moved in response to detection of the drag-and-drop gesture only if the drag-and-drop gesture is preceded by a move-activating touch gesture, such as a double-tap gesture or a long-press gesture, applied to the touchpad indicator, the move-activating touch gesture causes the touchpad indicator to be moved in response to detection of a subsequent drag-and-drop gesture applied to the touchpad indicator.

14. The method of claim 11, wherein the move gesture comprises detection of a multi-finger drag-and-drop gesture.

15. The method of claim 9, wherein the touchpad indicator is displayed in form of a superimposed graphical user interface object, wherein the superimposition is onto one or more of the graphical user interface objects that are displayed on the touchscreen.

16. The method of claim 9, wherein the cursor is moved in response to detection of the slide gesture originating from the location of the touchpad indicator only if the slide gesture is preceded by detection of a touchpad-activating touch gesture, such as a double-tap gesture or a long-press gesture, applied to the touchpad indicator, the touchpad-activating touch gesture causes the cursor to be moved in response to detection of the slide gesture originating from the touchpad indicator position.

17-22. (canceled)

23. A non-transitory computer-readable storage medium storing program instructions which, when executed by a processor of an electronic device, causes the electronic device to perform a method for user interaction with graphical user interface objects displayed on a touchscreen of the electronic device, the method comprising:
activating a touchpad indicator and display a cursor in response to a tap-and-hold gesture registered during a predefined time period at a same position of the touchscreen;
displaying the touchpad indicator at a touchpad indicator position, and to move a cursor in response to detection of a slide gesture applied to the touchpad indicator;
displaying and moving a cursor across a first part of the touchscreen in response to detection of a slide gesture being applied to a second part of the touchscreen, the second part of the touchscreen being different from the first part of the touchscreen; and
activating one of the graphical user interface objects indicated by the cursor upon at least one of
detection of a release of the slide gesture;
detection of a discontinuation of the slide gesture; or
detection of a force-press gesture applied to the second part of the touchscreen.

24. The non-transitory computer-readable storage medium of claim 23, the method comprising receiving user input indicating a desired location for the touch pad indicator on the touchscreen, and providing the touch pad indicator on the desired location of the touchscreen in response to the reception of the user input.

25. The non-transitory computer-readable storage medium of claim 24, the method comprising moving the touch pad indicator to the desired location of the touchscreen in response to detection of a move gesture applied to the touchpad indicator.

26. The non-transitory computer-readable storage medium of claim 25, the method comprising moving the touch pad indicator to the desired location of the touchscreen in response to detection of a drag-and-drop gesture applied to the touchpad indicator.
